(19) United States
(12) Patent Application Publication
(10) Pub. No.: US 2010/0042305 A1
(43) Pub. Date: Feb. 18, 2010

(54) Method for the Dynamic Calibration and Regulation of a Motor Vehicle Brake System

(75) Inventors: Faouzi Attallah, Darmstadt (DE); Andreas Neu, Kuhardt (DE); Martin Kallnik, Darmstadt (DE); Robert Schmidt, Kelkheim (DE)

Correspondence Address: RATNERPRESTIA, P.O. BOX 980, VALLEY FORGE, PA, 19482, US

(73) Assignee: Continental Teves AG & Co. oHG, Frankfurt (DE)

(21) Appl. No.: 12/298,163

(22) PCT Filed: Apr. 23, 2007
(86) PCT No.: PCT/EP07/53964

§ 371 Date: Mar. 19, 2009

(30) Foreign Application Priority Data
Apr. 26, 2006 (DE) 10 2006 020 038.1
Apr. 26, 2006 (DE) 10 2006 020 043.8
Sep. 13, 2006 (DE) 10 2006 042 928.1
Apr. 23, 2007 (DE) 10 2007 019 381.7

(51) Int. Cl. B60K 31/00

(52) U.S. Cl. 701/93; 701/70

(57) ABSTRACT

A method for the dynamic calibration and regulation of a brake system of a motor vehicle is disclosed. The method has at least one method phase and that, during a braking phase of the vehicle, a determination takes place of a vehicle declaration aᵥₑₕ at certain measurement times and of a required minimum deceleration a_{req} which is determined by an ACC system. The minimum deceleration a_{req} is set in relation to the vehicle deceleration aᵥₑₕ₋ and to an applied brake pressure p. A deceleration tolerance Δₐ of the brake system is determined as a result of the relation.

### CROSS REFERENCE TO RELATED APPLICATIONS

This application is the U.S. national phase application of PCT International Application No. PCT/EP2007/053964, filed Apr. 23, 2007, which claims priority to German Patent Application No. DE 10 2006 020 038.1, filed Apr. 26, 2006, German Patent Application No. DE 10 2006 020 043.8, filed Apr. 26, 2006, German Patent Application No. DE 10 2006 042 928.1, filed Sep. 13, 2006, and German Patent Application No. DE 10 2007 019 381.7, filed Apr. 23, 2007, the contents of such applications being incorporated by reference herein.

### BACKGROUND OF THE INVENTION

1. Field of the Invention

The invention relates to the field of motor vehicle brakes which are activated by a vehicle closed-loop and/or open-loop control system and are actuated by the driver of the vehicle.

2. Description of the Related Art

Various driver assistance systems are known for assisting the driver. Adaptive cruise controllers (Adaptive Cruise Control, ACC) control the velocity of the vehicle and the distance from other traveling vehicles. They are currently used in driving operations on motorways and on well laid-out clearways. This permits adjacent vehicles to travel in a line, during which process the distance and the velocity relative to adjacent vehicles are acquired and the traveling speed of the vehicle is adapted to that of the adjacent vehicle through braking interventions and engine control interventions, so that the load on the driver can be relieved in heavy traffic. In this context, a distance range between several meters to several tens of meters in front of the vehicle is generally covered by means of intelligent sensors, laser sensors or video sensors, and relative velocity is acquired for example from a Doppler measurement or derivation of the measured distance value over time. In addition to known systems, which operate in relatively high velocity ranges, adaptive cruise controllers which are also effective at relatively low velocities and even as far as the stationary state, referred to as ACC Low Speed Following Systems (ACC LSF), are also known which basically permit a following driving mode even in situations which are similar to traffic congestion.

The setting of the specific deceleration of the vehicle by means of automatic intervention into the brake control serves, within the scope of a following and inter-vehicle distance control system (ACC), both to increase the driving safety and, in particular, to improve the driver's comfort (assistance function). For this reason, the automatic deceleration should occur in a sufficiently uniform and therefore comfortable way.

DE 196 54 769 discloses vehicle open-loop and closed-loop control systems, such as an ACC system. Such systems control the velocity of the vehicle as a function of the previously set desired velocity and the distance from the vehicle traveling ahead, which is detected, for example, by means of a front-mounted radar system. If the safety distance becomes too small, the vehicle open-loop and closed-loop control system reduces the engine torque and/or brakes the vehicle autonomously. The driver of the vehicle is requested to intervene actively by corresponding signals if the driving situation requires relatively strong braking.

During the deceleration phase, the brake system is activated by the vehicle open-loop and closed-loop control systems without intervention by the driver if the engine torque is not sufficient to bring about the required braking. In order to increase the pressure at the wheels, pumps are used which pump the brake fluid from the circuit of the tandem master cylinder into the circuit which connects the wheels to one another. The main function of a brake system here is always to generate the desired or requested deceleration whenever the ACC system requires it, and then to bring about precisely the desired deceleration.

One disadvantage of this interplay between the ACC system and the brake system is that the braking force of the brake system is subjected to reduction over the course of time.

### SUMMARY OF THE INVENTION

The invention relates to the object of making available a method which detects the reduction in the braking force of the vehicle and carries out dynamic calibration and closed-loop control of the brake system. The term “dynamic” is defined in this context as closed-loop control and calibration which are always based on new current data in order to follow the behavior of the brake system and of the vehicle very closely.

The invention may be suitable for use in brake systems which are subject to heavy loading and which experience excessive wear and severe thermal or mechanical effects.

These and other aspects of the invention are illustrated in detail by way of the embodiments and are described with respect to the embodiments in the following, making reference to the Figures.

### BRIEF DESCRIPTION OF THE DRAWINGS

The invention is best understood from the following detailed description when read in connection with the accompanying drawing. Included in the drawing are the following figures:

FIG. 1: shows an example of the deviations between the acceleration requested by the ACC system and the acceleration of the vehicle, i.e. a_{req}, aᵥₑₕ,

FIG. 2: shows an example in which the acceleration a_{req} which is requested by the ACC system is illustrated in comparison to the acceleration aᵥₑₕ of the vehicle,

FIG. 3: shows examples illustrating the pressure p_{req} requested by the ACC system in comparison to the rotational speed of the vehicle wheel, and

FIG. 4: shows a further example of the pressure p_{req} which is requested by the ACC system in comparison to the acceleration aᵥₑₕ of the vehicle.

### DETAILED DESCRIPTION OF THE PREFERRED EMBODIMENTS

The method, according to aspects of the invention, is split into four method phases. According to aspects of the invention, these four method phases are configured in such a way that they can interact with one another in any desired sequence. In the text which follows, a sequential configuration of the method according to aspects of the invention is illustrated by way of example.

In the first method phase, the vehicle deceleration aᵥₑₕ and the deceleration a_{req} which is requested by the ACC system are acquired at certain measuring times during an ACC braking operation, and stored. After a statistically representative set of measured values has been determined, the deviation aᵥₑₕ−a_{req} is calculated and evaluated. An evaluation is used to check whether renewed calibration has to be carried out for the vehicle brake system. Furthermore, according to aspects of the invention, the behavior of the two decelerations a_{req} and aᵥₑₕ is used in order, if necessary, to carry out what is referred to as automatically closed-loop controlled calibration, since this does not require parameters outside the ACC closed-loop control stage.

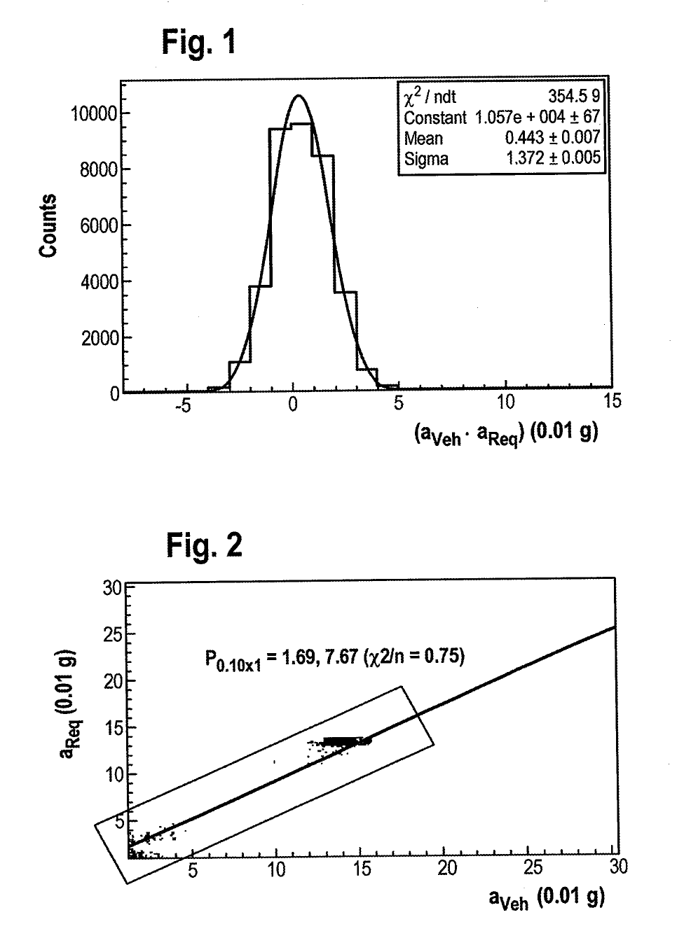

In the second method phase, the desired deceleration is compared directly with the deceleration of the vehicle which is brought about, i.e. on the basis of the difference. It is possible, for example, to use the deviation (aᵥₑₕ−a_{req}), as illustrated in FIG. 1, and particularly advantageously the mean value of the deviation m_{dev}. Of course, other measures of the inter-vehicle distance and means for the purpose of analyzing the deviation (aᵥₑₕ−a_{req}) can also be used.

For this reason, the calibration in the first method phase consists in shifting the deceleration requested by the ACC system by a fixed amount m_{dev}. In the case of the illustrated data example where m_{dev}=4.10⁻³ g, the positive value stands for the over-reaction of the vehicle, which implies that the immediately subsequent necessary deceleration should be shifted:

a_{req}→a_{req}−m_{dev} (1).

This method phase is advantageously used if the standard deviation is within the predefined tolerance limits. Otherwise, the system changes over into a further method phase so that calibration and closed-loop control can be carried out.

If it is not possible to use the first method phase owing to the aforesaid reasons, this indicates an indirect relationship between the vehicle and the decelerations requested by the ACC system. In order to indicate this relationship, these two parameters are evaluated, as illustrated in FIG. 2.

As is apparent from FIG. 2, a linear function

a_{req}=P₀+P₁×aᵥₑₕ (2)

can represent the collected data in an approximate fashion. This is a necessary condition for the calibration to continue to be capable of being used in the second method phase. This leads to a situation in which the deceleration a_{req} which is requested by the ACC system is replaced by a new value, such as for example:

a_{req}→P₀+P₁×a_{req} (3)

where P_{0,1} correspond to what are referred to as the “Fit Function” parameters, i.e. in this example the values 1.69 and 0.767, respectively.

If what is referred to as the “Fit Function” does not have an approximate linearity or if the measured data are distributed relatively broadly around this linearity, this type of calibration cannot be used and the method according to aspects of the invention goes into the third method phase.

In the ACC braking operation, the deceleration is converted into a requested pressure which is applied to the wheels. Further problems are therefore generated here by the behavior of the individual wheels and the reaction to the necessary pressure, and, of course, an imprecise pressure applied to the wheels gives rise to a similar situation. This case can arise due to a leak in one of the brake circuits.

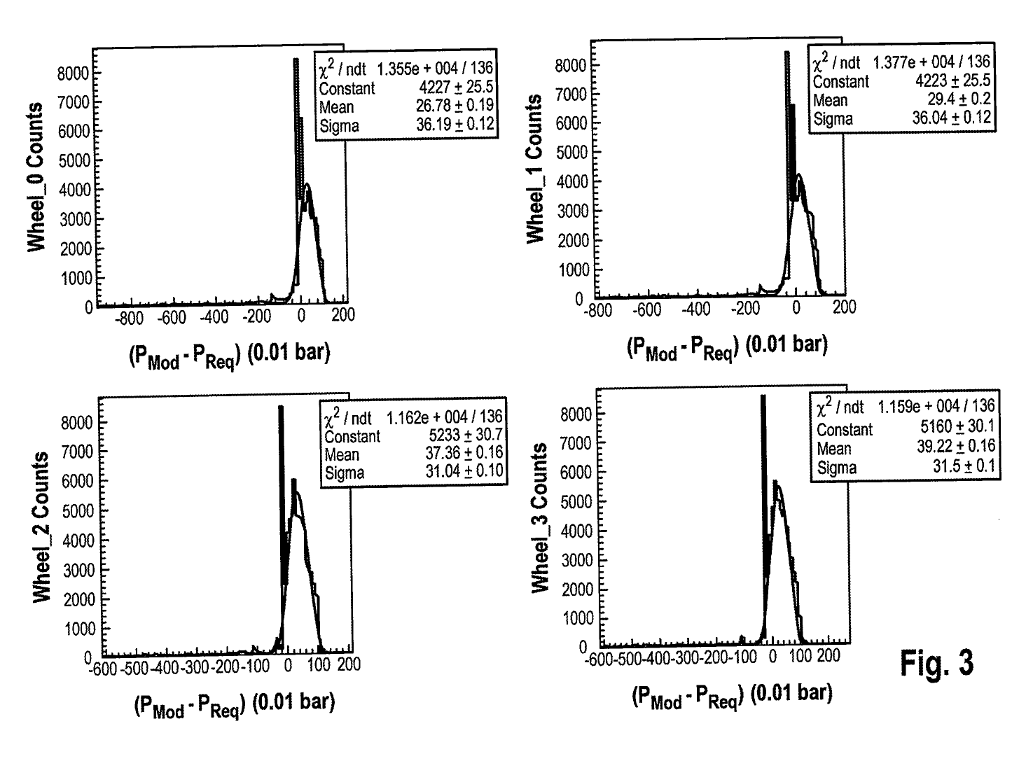

The deviations between the requested pressure and the tire pressure values which are illustrated in FIG. 3 are always within the predefined pressure tolerance in an ACC closed-loop control system. As is apparent from FIG. 3, the pressure which is applied to the wheels is somewhat higher than the requested pressure (average value>0). This explains the difference between the vehicle and the requested deceleration, and the average values and the standard deviations are within the 0.5 bar limits. Given this situation, this is acceptable if the predefined tolerance is above 0.5 bar.

If the average values and the standard deviations leave the predefined tolerance range, the incorrect or poor pressure should be corrected immediately.

If the calibration in the third method phase fails, the method according to aspects of the invention resorts to the complete closed-loop control of the brake system by checking the overall vehicle behavior in comparison to the applied pressure. Furthermore, the relationship pressure/deceleration can remain linear, even if the parameters have changed considerably.

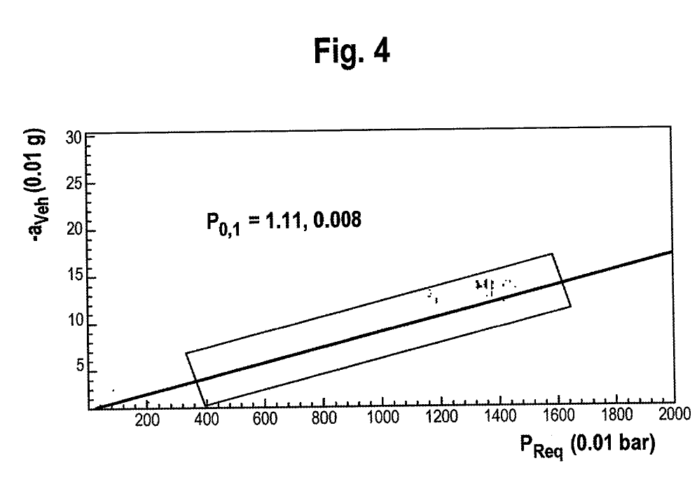

FIG. 4 gives an example of non-filtered data of the deceleration of the vehicle compared to the pressure requested by the ACC system. The precision of the parameters depends to a high degree on the quality of the data, which means that the data are filtered from the outset. If the vehicle has been newly manufactured, these data are acquired from a vehicle which is at the start of its entire operating time. Data from a vehicle brake system which operates without faults are therefore available and the parameters which are acquired as a result are stored as standard values. The parameters which are acquired on a daily basis are compared with the standard parameters, and an average value is used in order to avoid the influence of incorrect data which have been recorded during daily closed-loop control operations.

While preferred embodiments of the invention have been described herein, it will be understood that such embodiments are provided by way of example only. Numerous variations, changes and substitutions will occur to those skilled in the art without departing from the spirit of the invention. It is intended that the appended claims cover all such variations as fall within the spirit and scope of the invention.

1.-5. (canceled)

6. A method for dynamic calibration and closed-loop control of a brake system of a motor vehicle, said method comprising the steps of:
acquiring a vehicle deceleration aᵥₑₕ at certain measuring times during a braking phase of the vehicle;
implementing a minimum deceleration a_{req} for the motor vehicle;
placing the minimum deceleration a_{req} in relation with the vehicle deceleration aᵥₑₕ and with an applied brake pressure p; and
acquiring a deceleration difference Δₐ of the brake system as a result of the relation between the minimum deceleration a_{req} and the vehicle deceleration aᵥₑₕ.

7. The method as claimed in claim 6, wherein the implementing step comprises determining and requesting the minimum deceleration a_{req} by an Adaptive Cruise Control (ACC) system.

8. The method as claimed in claim 7,
wherein the requested minimum deceleration a_{req} is acquired using a linear function that depends on the vehicle deceleration aᵥₑₕ, as a result of which the minimum deceleration a_{req} that is requested by the ACC system is newly determined using said vehicle deceleration aᵥₑₕ.

9. The method as claimed in claim 6,
wherein the deceleration difference Δₐ serves as a criterion for the need to calibrate the brake system.

10. The method as claimed in claim 6,
wherein deceleration difference Δₐ acquiring step comprises acquiring the deceleration difference Δₐ between the vehicle deceleration aᵥₑₕ and the minimum deceleration a_{req} by forming differences.

11. The method as claimed in claim 10,
wherein the implementing step comprises determining and requesting the minimum deceleration a_{req} by an Adaptive Cruise Control (ACC) system;
wherein the deceleration difference Δₐ acquiring step is performed at certain measuring times within a certain time interval by forming differences, and at each measuring time a mean value of a deviation m_{dev} is calculated, and, as a result of which the minimum deceleration a_{req} that is requested by the ACC system is newly determined using said deviation m_{dev}.
